(19) United States
(12) Patent Application Publication
(10) Pub. No.: US 2006/0001347 A1
(43) Pub. Date: Jan. 5, 2006

(54) Cathode ray tube

(75) Inventor: Sung Hun Kim, Kumi-Si (KR)

Correspondence Address: BIRCH STEWART KOLASCH & BIRCH, PO BOX 747, FALLS CHURCH, VA, 22040-0747, US

(73) Assignee: LG. Philips Displays Korea CO., LTD., Kyungsangbuk-Do (KR)

(21) Appl. No.: 11/159,096

(22) Filed: Jun. 23, 2005

(30) Foreign Application Priority Data
Jun. 26, 2004 (KR) 2004-48668

(51) Int. Cl. H01J 29/80

(52) U.S. Cl. 313/407

(57) ABSTRACT

A cathode ray tube including a frame, wherein the frame includes a side wall, to which the shadow mask is welded, and a bottom wall extending from the side wall in a state of being bent inwardly of the frame, and the frame has a side wall height and a bottom wall width defined in a cross section of the frame taken along the longer axis (x), to satisfy a condition “1.29≦FW_x/FH_x≦1.90” where “FW_x” represents the side wall height in the cross section of the frame taken along the longer axis (x), and “FH_x” represents the bottom wall width in the cross section of the frame taken along the longer axis (x). In accordance with this frame structure, it is possible to increase the intrinsic frequency of the frame, and thus, to prevent a degradation in color purity caused by a howling phenomenon.

### BACKGROUND OF THE INVENTION

1. Field of the Invention

The present invention relates to a cathode ray tube, and, more particularly, to a cathode ray tube which includes a frame designed to have a side wall having an optimal height and a bottom wall having an optimal width to solve problems caused by a howling phenomenon, such as a degradation in the color purity of an image reproduced by the cathode ray tube.

2. Description of the Related Art

A conventional cathode ray tube will be described hereinafter with reference to FIG. 1.

FIG. 1 is a sectional view illustrating a structure of a conventional cathode ray tube. As shown in FIG. 1, the conventional cathode ray tube includes a panel 1, a funnel 2, a shadow mask 3, a phosphor surface 4, a deflection yoke 5, a frame 6, a spring 7, and an inner shield 8.

Operation of the cathode ray tube having the above-mentioned configuration will be described. An electron beam, which is emitted from an electron gun travels toward the panel 1, and is then vertically and horizontally deflected by the deflection yoke 5, which is arranged at a neck of the funnel 2.

The deflected electron beam passes through slots formed through the shadow mask 3, and reaches the phosphor surface 4, which is coated on an inner surface of the panel 1. The phosphor surface 4 emits light, using the energy of the electron beam, so that an image is reproduced.

The frame 6, which is also included in the cathode ray tube, supports the shadow mask 3. The spring 7 is arranged to tightly fit the frame 6 with an inner surface of the panel 1.

If the electron beam is influenced by an external geomagnetic field, the travel path of the electron beam is deflected, so that the color purity of the reproduced image is degraded. The inner shield 8, which is included in the cathode ray tube, is adapted to reduce the influence of the geomagnetic field.

Recently, cathode ray tubes have been advanced to have a slim structure, in order to enhance the competitiveness thereof. However, since such slim cathode ray tubes are unstable in terms of their structure, they must have enhanced qualities, as compared to conventional cases. In particular, problems incurred in cathode ray tubes due to their structures include a shape inconformity between a frame and a panel, a halation phenomenon, and a howling phenomenon.

Where cathode ray tubes are used for TVs other than monitors of general computers, there may be a howling phenomenon. For example, where the above-mentioned cathode ray tube is used for a TV, it receives an audio signal together with an image signal, and thus, transmits sound into air through a speaker mounted in the TV. At this time, the speaker vibrates to externally output the audio signal. Due to the vibration of the speaker, the panel 1 and funnel 2 of the cathode ray tube vibrate. Thus, a howling phenomenon occurs.

When the panel 1 vibrates, this vibration is transmitted to the shadow mask 3 connected to the inner surface of the panel 1 via the spring 7, so that the shadow mask 3 vibrates. Due to the vibration of the shadow mask 3, the position of each slot of the shadow mask 3 is shifted, so that electron beams cannot strike accurate portions of the phosphor surface 4. As a result, a degradation in the color purity of the reproduced image occurs.

In association with such a howling phenomenon, there may be a more serious problem. That is, resonance occurs in the cathode ray tube when the intrinsic frequency of an element included in the cathode ray tube is within the frequency band of an external sound source. When the element vibrates due to the resonance, the color purity degradation may reach a serious level.

In order to prevent such a resonance phenomenon, it is necessary to design elements of the cathode ray tube such that the intrinsic frequency of each element is outside the frequency band of the external sound source. Generally, it is desirable to design the elements of the cathode ray tube such that each element has an intrinsic frequency as high as possible, in order to allow the intrinsic frequency to be outside the frequency band of the external sound source.

In particular, in the case of the frame 6, which may be used in general cathode ray tubes, the primary intrinsic frequency of the frame 6 is calculated to be about 45 Hz through numerical analysis. However, when the primary intrinsic frequency of the frame 6 is at least 50 Hz, it is possible to effectively prevent generation of a howling phenomenon caused by resonance generated due to an external vibrating sound source of a low frequency band. Accordingly, cathode ray tubes, which use a frame having a conventional structure as in the frame 6, exhibit a degradation in color purity caused by the howling phenomenon, and severe screen vibration caused by the resonance phenomenon.

### SUMMARY OF THE INVENTION

The present invention has been made in view of the problems incurred in the above-mentioned related art, and it is an object of the invention to provide a cathode ray tube which includes a frame appropriately designed to have a side wall having an optimal height and a bottom wall having an optimal width to increase the intrinsic frequency of the frame, and thus, to prevent occurrence of a howling phenomenon caused by resonance.

Another object of the invention is to provide a cathode ray tube which includes a frame appropriately designed to have side and bottom wall structures capable of preventing occurrence of an electron beam shielding phenomenon and a halation phenomenon.

In accordance with one aspect, the present invention provides a cathode ray tube comprising a panel, a funnel coupled to a rear end of the panel, a shadow mask formed with a plurality of slots to perform a color selecting function for electron beams, and a frame adapted to support the shadow mask, wherein the frame comprises a side wall, to which the shadow mask is welded, and a bottom wall extending from the side wall in a state of being bent inwardly of the frame, and the side wall of the frame has a height defined in a cross section of the frame taken along a longer axis (x) of the frame to satisfy the following condition, and the bottom wall of the frame has a width defined in the cross section of the frame taken along the longer axis (x) of the frame to satisfy the following condition:
1.29≦FW_{—}x/FH_{—}x≦1.90
where, “FW_x” represents the height of the side wall in the cross section of the frame taken along the longer axis (x) of the frame, and “FH_x” represents the width of the bottom wall in the cross section of the frame taken along the longer axis (x) of the frame.

In accordance with another aspect of the present invention, the side wall of the frame has a height defined in a cross section of the frame taken along a short axis (y) of the frame to satisfy the following condition, and the bottom wall of the frame has a width defined in the cross section of the frame taken along the shorter axis (y) of the frame to satisfy the following condition:
0.70≦FW_{—}y/FH_{—}y≦1.10
where, “FW_y” represents the height of the side wall in the cross section of the frame taken along the shorter axis (y) of the frame, and “FH_y” represents the width of the bottom wall in the cross section of the frame taken along the shorter axis (y) of the frame.

In accordance with another aspect of the present invention, the side wall of the frame has a height defined in a cross section of the frame taken along a diagonal axis (d) of the frame to satisfy the following condition, and the bottom wall of the frame has a width defined in the cross section of the frame taken along the diagonal axis (d) of the frame to satisfy the following condition:
1.49≦FW_{—}d/FH_{—}d≦1.91
where, “FW_d” represents the height of the side wall in the cross section of the frame taken along the diagonal axis (d) of the frame, and “FH_d” represents the width of the bottom wall in the cross section of the frame taken along the diagonal axis (d) of the frame.

When the side wall and bottom wall of the frame are designed to satisfy at least one of the above-described conditions, an electron beam shielding phenomenon wherein shade is formed on the screen of the panel may occur. A halation phenomenon may also occur due to secondary electrons generated when electron beams strike an inner surface of the frame. In order to prevent occurrence of such phenomena, the cathode ray tube is designed to further satisfy conditions as described below.

That is, the cathode ray tube may satisfy a condition “1.80≦Dx/L≦2.52” where “L” represents a distance from a deflection center of the cathode ray tube to an edge of a skirt of the panel in a direction parallel to a central axis (z) of the panel, and “Dx” represents a distance from the central axis (z) of the panel to an edge of the bottom wall of the frame in a direction parallel to the longer axis (x).

The cathode ray tube may also satisfy a condition “0.90≦Dy/L≦1.41” where “Dy” represents a distance from the central axis (z) of the panel to an edge of the bottom wall of the frame in a direction parallel to the shorter axis (y). Also, the cathode ray tube may satisfy a condition “1.99≦Dd/L≦3.04” where “Dd” represents a distance from the central axis (z) of the panel to an edge of the bottom wall of the frame in a direction parallel to the diagonal axis (d).

Also, the cathode ray tube may satisfy a condition “0.80≦θx/βx≦0.90” where “θx” represents a deflection angle, at which an electron beam strikes a reflecting surface of a reflecting tip of the frame extending along the longer axis (x), and “βx” represents an angle formed between a line extending perpendicularly to the longer-axis reflecting surface of the reflecting tip and the central axis (z) of the panel.

In addition, the cathode ray tube may satisfy a condition “0.65≦θy/βy≦0.85” where “θy” represents a deflection angle, at which an electron beam strikes a reflecting surface of the reflecting tip of the frame extending along the shorter axis (y), and “βy” represents an angle formed between a line extending perpendicularly to the shorter-axis reflecting surface of the reflecting tip and the central axis (z) of the panel. Also, the cathode ray tube may satisfy a condition “0.80≦θd/βd≦0.95” where “θd” represents a deflection angle, at which an electron beam strikes a reflecting surface of the reflecting tip of the frame extending along the diagonal axis (d), and “βd” represents an angle formed between a line extending perpendicularly to the diagonal-axis reflecting surface of the reflecting tip and the central axis (z) of the panel.

### BRIEF DESCRIPTION OF THE DRAWINGS

The above objects, and other features and advantages of the present invention will become more apparent after reading the following detailed description when taken in conjunction with the drawings, in which:

FIG. 1 is a sectional view illustrating a structure of a conventional cathode ray tube;

FIG. 2 is a sectional view illustrating a part of a cathode ray tube according to the present invention;

FIG. 3 is a perspective view illustrating the frame included in the cathode ray tube according to the present invention;

FIG. 4a to FIG. 4c are cross-sectional views of the frame taken along respective axes of the frame shown in FIG. 3;

FIGS. 5 and 6 are sectional views of a part of a cathode ray tube, explaining an electron beam shielding phenomenon and a halation phenomenon;

FIG. 7 is a schematic view illustrating a slimness of the cathode ray tube according to the present invention; and

FIG. 8 is a schematic view illustrating the cross section of a yoke of a funnel applied to the cathode ray tube according to the present invention.

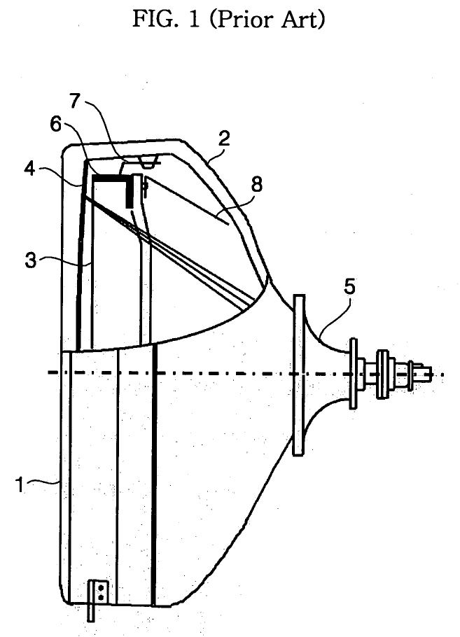

### DESCRIPTION OF THE PREFERRED EMBODIMENTS

Hereinafter, exemplary embodiments of a cathode ray tube according to the present invention will be described with reference to the annexed drawings. In the following description, the same elements are referred to by the same title and designated by the same reference numeral.

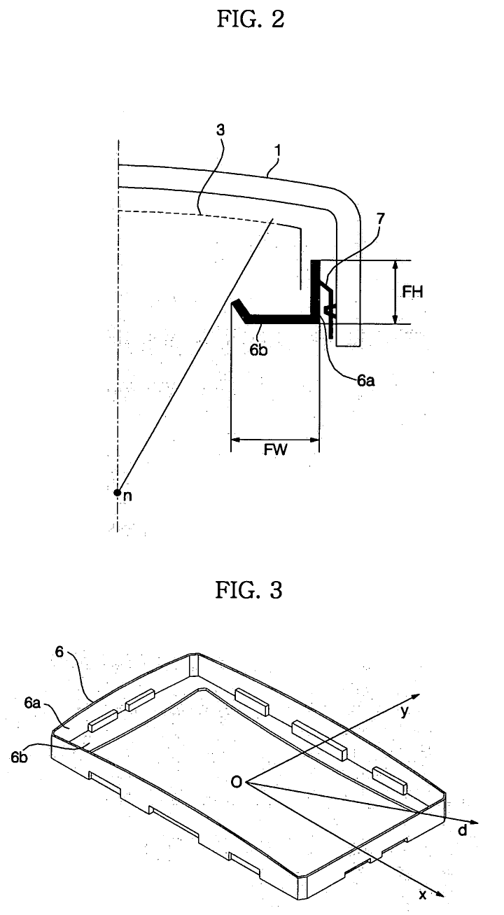

FIG. 2 is a sectional view illustrating a part of a cathode ray tube according to the present invention.

As shown in FIG. 2, an electron beam emitted from an electron gun is vertically and horizontally deflected toward a panel 1 of the cathode ray tube through predetermined vertical and horizontal angles by a deflection yoke mounted near a neck of a funnel. The point where the deflection of the electron beam begins is referred to as a deflection center n.

After being deflected at the deflection center n, the electron beam passes through a desired slot of a shadow mask 3, and then reaches a desired portion of a phosphor surface 4 coated on an inner surface of the panel 1. The portion of the phosphor surface 4 emits light by the energy of the electron beam, thereby reproducing an image.

The shadow mask 3 is welded to a frame 6 (FIG. 3) such that the shadow mask 3 is maintained while being spaced apart from the panel 1 by a desired distance. The frame 6 includes a side wall 6a, to which the shadow mask 3 is welded, and a bottom wall 6b extending from one edge of the side wall 6a in a state of being bent such that the bottom wall 6b is substantially parallel to the panel 1. The bottom wall 6b has an edge bent through a predetermined angle to form a reflecting tip.

As shown in FIG. 2, the height of the side wall 6a of the frame 6 is defined as “FH”, and the width of the bottom wall 6b of the frame 6 is defined as “FW”.

Meanwhile, the cathode ray tube also includes a spring 7 adapted to couple the panel 1 and frame 6 such that the shadow mask 3 is maintained in parallel to the panel 1.

FIG. 3 is a perspective view illustrating the frame included in the cathode ray tube according to the present invention. As described above, the frame 6 includes the side wall 6a and bottom wall 6b. In FIG. 3, the longer axis, shorter axis, and diagonal axis of the frame 6 are defined as an x-axis, a y-axis, and a d-axis, respectively.

The axes of the frame 6 cross at the center o of an opening defined by an inner edge of the bottom wall 6b of the frame 6. The cross point o is positioned on a central axis of the panel 1.

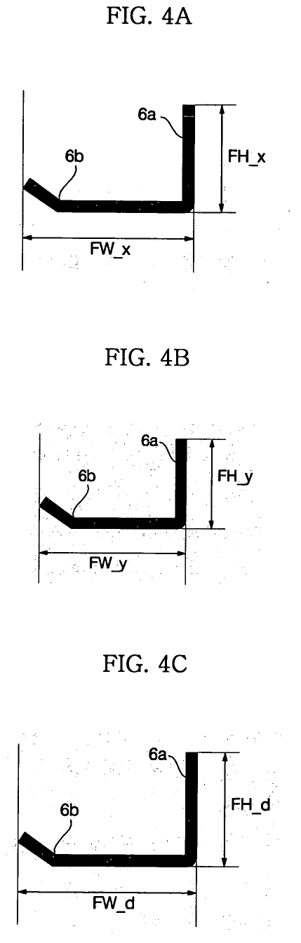

FIG. 4a to FIG. 4c are cross-sectional views of the frame taken along respective axes of the frame shown in FIG. 3. FIG. 4a shows cross sections of the side wall 6a and bottom wall 6b of the frame 6 taken along the longer axis x of the frame 6. Similarly, FIGS. 4b and 4c show cross sections of the side wall 6a and bottom wall 6b of the frame 6 taken along the shorter axis y and diagonal axis d of the frame 6, respectively.

In the cross section taken along the longer axis x, the height of the side wall 6a and the width of the bottom wall 6b are defined as “FH_x” and “FW_x”, respectively. In the cross section taken along the shorter axis y, the height of the side wall 6a and the width of the bottom wall 6b are defined as “FH_y” and “FW_y”, respectively. In the cross section taken along the diagonal axis d, the height of the side wall 6a and the width of the bottom wall 6b are defined as “FH_d” and “FW_d”, respectively.

In accordance with the present invention, the height of the side wall 6a and the width of the bottom wall 6b in the frame 6 of the cathode ray tube, which are defined as described above, are adjusted to suppress a howling phenomenon caused by vibrations generated when sound is outputted through a speaker. This adjustment will be described in detail hereinafter.

When the height of the side wall 6a and the width of the bottom wall 6b are excessively increased or reduced, problems associated with shape inconformity, an electron beam shielding phenomenon, and a halation phenomenon. Therefore, it is necessary to appropriately adjust the height of the side wall 6a and the width of the bottom wall 6b.

Thus, it is important to appropriately determine the height of the side wall 6a and the width of the bottom wall 6b within ranges capable of preventing occurrence of the above-described problems, respectively, while enabling the frame 6 to have an intrinsic frequency as high as possible.

Tables 1 and 2 provide diverse data about the height of the side wall 6a and the width of the bottom wall 6b in the frame 6 according to the present invention. Tables 1 and 2 also provide data about the ratio of the width of the bottom wall 6b to the height of the side wall 6a, and the intrinsic frequency of the frame 6 according to the ratio.

The length values given in Tables 1 and 2 are associated with a 32 in. cathode ray tube. These length values may be applied to cathode ray tubes of other sizes, for example, 28 to 32 in., to produce desirable effects.

Table 1 is associated with the case in which the width of the bottom wall 61 is varied while the height of the side wall 6a is constant.

TABLE 1

| | Present | Present | Present | Present | Present | Conventional |
|---|---|---|---|---|---|---|
| | Invention 1 | Invention 2 | Invention 3 | Invention 4 | Invention 5 | Case |
| FW_x(mm) | 63 | 68 | 78 | 88 | 93 | 56 |
| FW_y(mm) | 42 | 48 | 53 | 58 | 66 | 42 |
| FW_d(mm) | 64 | 70 | 75 | 80 | 82 | 51 |
| FH_x(mm) | 49 | 49 | 49 | 49 | 49 | 57 |
| FH_y(mm) | 60 | 60 | 60 | 60 | 60 | 71 |
| FH_d(mm) | 43 | 43 | 43 | 43 | 43 | 49 |
| FW_x/FH_x | 1.29 | 1.39 | 1.58 | 1.80 | 1.90 | 0.98 |
| (mm) | | | | | | |
| FW_y/FH_y | 0.70 | 0.81 | 0.89 | 0.97 | 1.10 | 0.60 |
| (mm) | | | | | | |
| FW_d/FH_d | 1.49 | 1.63 | 1.74 | 1.86 | 1.91 | 1.04 |
| (mm) | | | | | | |
| Intrinsic | 50 Hz | 52 Hz | 55 Hz | 60 Hz | 65 Hz | 45 Hz |
| Frequency | | | | | | |

The data given in Table 1 represents heights of the side wall 6a and widths of the bottom wall 6b in cross sections of the frame 6 respectively taken along the longer axis x, shorter axis y, and diagonal axis d of the frame 6. In particular, the longer-axis, shorter-axis, and diagonal-axis heights of the side wall 6a in each of the five examples according to the present invention are set to be 49 mm, 60 mm, and 43 mm, which are shorter than those of the conventional case, respectively. Meanwhile, the longer-axis, shorter-axis, and diagonal-axis widths of the bottom wall 6b in each of the five examples according to the present invention are set to be different from those of the remaining examples, while being longer than those of the conventional case.

Referring to Table 1, it can be seen that the examples according to the present invention have 1.29, 1.39, 1.58, 1.80, and 1.90, respectively, as the ratio of the width of the bottom wall 6b to the height of the side wall 6a in the cross section of the frame 6 taken along the longer axis x of the frame 6, FW_x/FH_x. The examples according to the present invention also have 0.70, 0.81, 0.89, 0.97, and 1.10, respectively, as the ratio of the width of the bottom wall 6b to the height of the side wall 6a in the cross section of the frame 6 taken along the shorter axis y of the frame 6, FW_y/FH_y, and have 1.49, 1.63, 1.74, 1.86, and 1.91, respectively, as the ratio of the width of the bottom wall 6b to the height of the side wall 6a in the cross section of the frame 6 taken along the diagonal axis x of the frame 6, FW_d/FH_d.

Based on the above-described values, the examples according to the present invention have 50 Hz, 52 Hz, 55 Hz, 60 Hz, and 65 Hz, respectively, as the intrinsic frequency of the frame 6 thereof. Accordingly, it is possible to prevent occurrence of a resonance phenomenon when low-frequency sound is generated, and thus, to eliminate a degradation in color purity caused by a howling phenomenon.

TABLE 2

| | Present | Present | Present | Present | Present | Conventional |
|---|---|---|---|---|---|---|
| | Invention 1 | Invention 2 | Invention 3 | Invention 4 | Invention 5 | Case |
| FW_x(mm) | 78 | 78 | 78 | 78 | 78 | 56 |
| FW_y(mm) | 53 | 53 | 53 | 53 | 53 | 42 |
| FW_d(mm) | 75 | 75 | 75 | 75 | 75 | 51 |
| FH_x(mm) | 42 | 46 | 49 | 52 | 54 | 57 |
| FH_y(mm) | 53 | 55 | 60 | 65 | 67 | 71 |
| FH_d(mm) | 38 | 40 | 43 | 46 | 48 | 49 |
| FW_x/FH_x | 1.86 | 1.70 | 1.58 | 1.50 | 1.44 | 0.98 |
| (mm) | | | | | | |
| FW_y/FH_y | 1.86 | 1.70 | 1.58 | 1.50 | 1.44 | 0.98 |
| (mm) | | | | | | |
| FW_d/FH_d | 1.97 | 1.88 | 1.74 | 1.63 | 1.56 | 1.04 |
| (mm) | | | | | | |
| Intrinsic | 62 Hz | 58 Hz | 55 Hz | 51 Hz | 50 Hz | 45 Hz |
| Frequency | | | | | | |

Table 2 is associated with the case in which the height of the side wall 6a is varied while the width of the bottom wall 61 is constant. In particular, Table 2 describes data obtained by varying the height of the side wall 6a under the condition in which the longer-axis, shorter-axis, and diagonal-axis widths of the bottom wall 6b in each of the five examples according to the present invention are set to be 78 mm, 53 mm, and 75 mm, which are longer than those of the conventional case, respectively.

Referring to Table 2, it can be seen that the examples according to the present invention have 1.86, 1.70, 1.58, 1.50, and 1.44, respectively, as the ratio FW_x/FH_x in the cross section of the frame 6 taken along the longer axis x of the frame 6, have 1.00, 0.96, 0.89, 0.82, and 0.79, respectively, as the ratio FW_y/FH_y in the cross section of the frame 6 taken along the shorter axis y of the frame 6, and have 1.97, 1.88, 1.74, 1.63, and 1.56, respectively, as the ratio FW_d/FH_d in the cross section of the frame 6 taken along the diagonal axis x of the frame 6.

Based on the above-described values, the examples according to the present invention have 62 Hz, 58 Hz, 55 Hz, 51 Hz, and 50 Hz, respectively, as the intrinsic frequency of the frame 6 thereof. Accordingly, it is possible to reduce the howling problem caused by a resonance phenomenon occurring when sound is outputted, as compared to the conventional case in which the frame 6 has an intrinsic frequency of 45 Hz.

After analyzing the data given in Tables 1 and 2, it can be understood that the objects of the present invention can be accomplished by setting the ratio FW_x/FH_x in the cross section of the frame 6 taken along the longer axis x of the frame 6 to be within a range of 1.29 to 1.90, setting the ratio FW_y/FH_y in the cross section of the frame 6 taken along the shorter axis y of the frame 6 to be within a range of 0.70 to 1.10, and setting the ratio FW_d/FH_d in the cross section of the frame 6 taken along the diagonal axis x of the frame 6 to be within a range of 1.49 to 1.91 such that the frame 6 has an intrinsic frequency as high as possible.

Meanwhile, when the values given in Tables 1 and 2 in association with the height of the side wall 6a and the width of the bottom wall 6b are applied to a cathode ray tube having a size of 28 to 32 inches, desirable effects are obtained. In this case, it is preferred that the frame 6 satisfy conditions “42 mm≦FH_x≦54 mm” and “63 mm≦FW_x≦93 mm” given for the height of the side wall 6a and the width of the bottom wall 6b in the cross section of the frame 6 taken along the longer axis x of the frame 6.

Also, it is preferred that the frame 6 satisfy conditions “53 mm≦FH_y≦67 mm” and “42 mm≦FW_y≦66 mm” given for the height of the side wall 6a and the width of the bottom wall 6b in the cross section of the frame 6 taken along the shorter axis y of the frame 6. It is also preferred that the frame 6 satisfy conditions “38 mm≦FH_d≦48 mm” and “64 mm≦FW_d≦82 mm” given for the height of the side wall 6a and the width of the bottom wall 6b in the cross section of the frame 6 taken along the diagonal axis d of the frame 6.

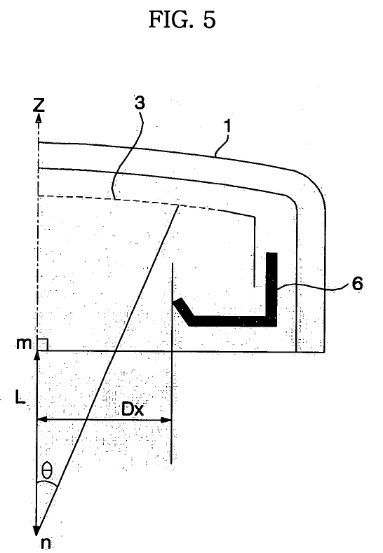

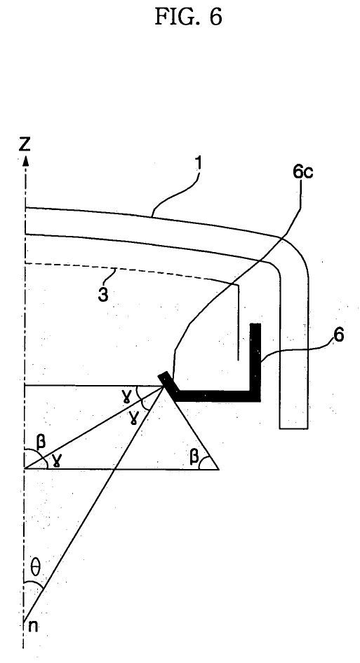

Meanwhile, the design of the frame 6 to optimize the height of the side wall 6a and the width of the bottom wall 6b must be made, taking into consideration the problems associated with the electron beam shielding phenomenon and halation phenomenon. This will be described in detail with reference to FIGS. 5 and 6.

FIGS. 5 and 6 are sectional views of a part of a cathode ray tube, explaining an electron beam shielding phenomenon and a halation phenomenon. The cathode ray tube shown in FIGS. 5 and 6 includes a panel 1, a shadow mask 3, a frame 6 fixedly coupled with the inner surface of the panel 1 to support the shadow mask 3, as in the above-described cathode ray tube.

In FIGS. 5 and 6, the central axis of the panel 1 is defined as a z-axis. When a line extends from an edge of a skirt extending perpendicularly from an effective screen portion of the panel 1 such that the line perpendicularly crosses the central axis z of the panel, the line meets the central axis z of the panel at a point m.

In this case, it is preferred that the cathode ray tube satisfy a condition “1.80≦Dx/L≦2.52”, where “L” represents the distance from a deflection center n of the cathode ray tube to the edge of the skirt of the panel 1 in a direction parallel to a central axis z of the panel 1, and “Dx” represents the distance from the central axis z of the panel 1 to the edge of the bottom wall of the frame 6 in a direction parallel to the longer axis x.

It is also preferred that the cathode ray tube satisfy a condition “0.90≦Dy/L≦1.41”, where “Dy” represents the distance from the central axis z of the panel 1 to the edge of the bottom wall of the frame 6 in a direction parallel to the shorter axis y.

It is also preferred that the cathode ray tube satisfy a condition “1.99≦Dd/L≦3.04”, where “Dd” represents the distance from the central axis z of the panel 1 to the edge of the bottom wall of the frame 6 in a direction parallel to the diagonal axis d.

Data associated with the conditions to be satisfied by the cathode ray tube will be described in detail with reference to the following Table 3.

TABLE 3

| | | | | | Conventional |
|---|---|---|---|---|---|
| | Example 1 | Example 2 | Example 3 | Example 4 | Case |
| L (mm) | 92 | 96 | 134.2 | 144 | 240.5 |
| Dx (mm) | 232.0 | 234.0 | 255.4 | 259.0 | 277.0 |
| Dy (mm) | 130.0 | 125.8 | 138.2 | 130.0 | 148.9 |
| Dd (mm) | 279.5 | 272.2 | 296.3 | 286.0 | 319.8 |
| Dx/L | 2.52 | 2.44 | 1.90 | 1.80 | 1.15 |
| Dy/L | 1.41 | 1.31 | 1.03 | 0.90 | 0.62 |
| Dd/L | 3.04 | 2.84 | 2.21 | 1.99 | 1.33 |

The values given in Table 3 are associated with the case in which the cathode ray tube has a size of 32 inches. The length values L, Dx, Dy, and Dd may be applied to cathode ray tubes of other sizes, for example, 28 to 32 in., to produce desirable effects.

Where the frame 6 is applied to a slim cathode ray tube, it is necessary to appropriately modify the structure of the frame 6 because the slim cathode ray tube has an increased deflection angle θ, as compared to that of general cathode ray tubes. That is, when the bottom wall 6b of the frame 6 has an excessively large width, electron beams may strike the frame 6, so that an electron beam shielding phenomenon wherein shade is formed on the screen of the panel 1 may occur. On the other hand, when the bottom wall 6b of the frame 6 has an excessively small width, electron beams strike the inner surface of the frame 6, thereby producing secondary electrons, so that a halation phenomenon may occur due to the secondary electrons. Accordingly, it is necessary to prevent occurrence of such phenomena.

Referring to Table 3, it can be seen that Example 1 has 232.0 mm, 130.0 mm, 279.5 mm, and Example 4 has 259.0 mm, 130.0 mm, and 286.0 mm as the distances from the central axis z of the panel 1 to the edge of the bottom wall of the frame 6 in longer-axis, shorter-axis, and diagonal-axis directions, respectively.

Referring to Table 3, it can also be seen that Example 1 has 2.52, 1.41, and 3.04, and Example 4 has 1.80, 0.90, and 1.99 as respective ratios of the above-described distances to the distance L from the deflection center n of the cathode ray tube to the edge of the skirt of the panel 1 in the central-axis direction, that is, Dx/L, Dy/L, and Dd/L, and these values are larger than those of the conventional case.

Accordingly, when the values Dx/L, Dy/L, and Dd/L satisfy conditions “1.80≦Dx/L≦2.52”, “0.90≦Dy/L≦1.41”, and “1.99≦Dd/L≦3.04”, respectively, it is possible to effectively prevent problems caused by the electron beam shielding phenomenon and halation phenomenon.

Meanwhile, it may be possible to prevent the halation phenomenon caused by electron beams striking a reflecting tip 6c (FIG. 6) formed at the edge of the bottom wall of the frame 6 in a state of being bent through a certain angle, by appropriately adjusting the bending angle of the reflecting tip 6c. This will be described in detail with reference to the following Table 4.

TABLE 4

| | | | | | Conventional |
|---|---|---|---|---|---|
| | Example 1 | Example 2 | Example 3 | Example 4 | Case |
| ⊖x | 65.0 | 63.2 | 58.2 | 54.0 | 45.3 |
| ⊖y | 55.0 | 47.3 | 41.6 | 38.8 | 29.3 |
| ⊖d | 70.0 | 66.7 | 62.0 | 56.0 | 49.8 |
| Bx | 72.2 | 71.6 | 69.1 | 67.8 | 62.7 |
| By | 64.4 | 63.6 | 60.8 | 59.4 | 54.7 |
| Bd | 73.9 | 73.3 | 71.0 | 69.7 | 64.9 |
| θx/βx | 0.90 | 0.88 | 0.84 | 0.80 | 0.72 |
| θy/βy | 0.85 | 0.74 | 0.68 | 0.65 | 0.54 |
| θd/βd | 0.95 | 0.91 | 0.87 | 0.80 | 0.77 |

In Table 4, “θx” represents a deflection angle, at which an electron beam strikes a reflecting surface of the reflecting tip 6c of the frame 6 extending along the longer axis x of the frame 6, and “βx” represents an angle formed between a line extending perpendicularly to the longer-axis reflecting surface of the reflecting tip 6c and the central axis z of the panel 1. Also, the angle formed between the line extending perpendicularly to a reflecting surface of the reflecting tip 6c and the travel direction of the electron beam may be defined as “γ”.

In Table 4, “θy” represents a deflection angle, at which an electron beam strikes a reflecting surface of the reflecting tip 6c of the frame 6 extending along the shorter axis y of the frame 6, and “βy” represents an angle formed between a line extending perpendicularly to the shorter-axis reflecting surface of the reflecting tip 6c and the central axis z of the panel 1. Also, “θd” represents a deflection angle, at which an electron beam strikes a reflecting surface of the reflecting tip 6c of the frame 6 extending along the diagonal axis d of the frame 6, and “βd” represents an angle formed between a line extending perpendicularly to the diagonal-axis reflecting surface of the reflecting tip 6c and the central axis z of the panel 1.

In order to effectively prevent occurrence of a halation phenomenon, the cathode ray tube has values θx and βx satisfying a condition “0.80≦θx/βx≦0.90”.

For the same purpose, the cathode ray tube has values θy and βy satisfying a condition “0.65≦θy/βy≦0.85”, and values θd and βd satisfying a condition “0.80≦θd/βd≦0.95”.

When the reflecting tip 6c is designed to satisfy the above-described conditions, electron beams, which strike the reflecting tip 6c, travel in directions perpendicular to the central axis z of the panel 1, respectively. Accordingly, it is possible to prevent electron beams from traveling toward the panel 1 after striking the reflecting tip 6c, and thus, to cope with problems caused by a halation phenomenon.

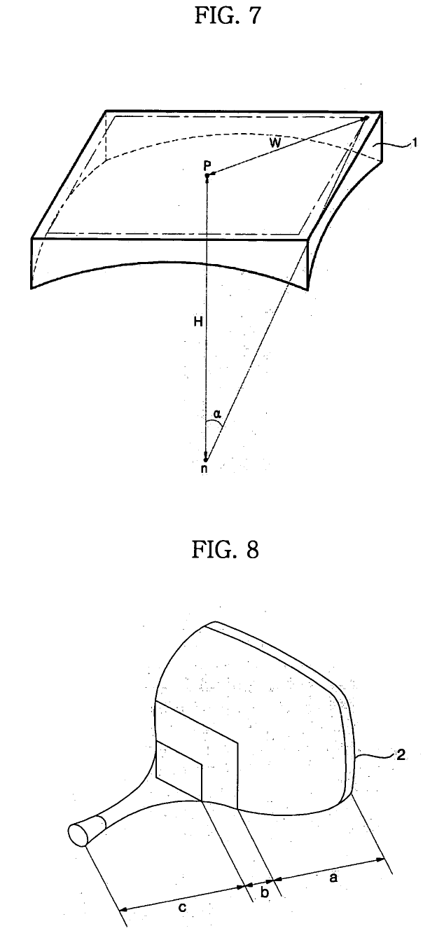

Meanwhile, where the cathode ray tube according to the present invention has a slim structure, the cathode ray tube can exhibit superior effects in accordance with the above-described structure improvement. This will be described in detail with reference to FIGS. 7 and 8.

FIG. 7 is a schematic view illustrating a slimness of the cathode ray tube according to the present invention. FIG. 8 is a schematic view illustrating the cross section of a yoke of a funnel applied to the cathode ray tube according to the present invention.

In FIG. 7, “H” represents the distance from a deflection center n of the cathode ray tube to a center P of the outer surface of a panel 1 included in the cathode ray tube, and “W” represents the distance from the outer surface center P of the panel 1 to an edge of the effective screen of the panel 1 in a diagonal direction of the panel 1.

When the values H and W satisfy a condition “tan⁻¹(W/H)≧1.05”, the cathode ray tube exhibits a deflection angle of about 120° or more. Here, the deflection angle corresponds to 2*α, and “α” represents an angle formed between a line extending from the deflection center n to the outer surface center P and a line extending from the deflection center n to an effective screen edge portion of the panel 1, through which a line extending from the outer surface center P in the diagonal direction of the panel 1 passes. When the cathode ray tube has a slim structure exhibiting a deflection angle of about 120° or more, it is possible to provide superior effects by applying the above-described structure improvement according to the present invention to the cathode ray tube.

Meanwhile, where the cathode ray tube has a slim structure, the deflection range of electron beams is widened due to an increase in deflection angle. As a result, the amount of current required to deflect electron beams is increased, so that consumption of electric power is increased.

In order to solve this problem, accordingly, it is necessary to reduce the amount of current required for deflection of electron beams. The current amount reduction may be achieved by appropriately modifying the funnel structure of the cathode ray tube. Referring to FIG. 8, a funnel 2 of the cathode ray tube is illustrated which includes a body a, a yoke b, and a neck c. In accordance with the present invention, it is possible to reduce the amount of current required for deflection of electron beams by design the funnel 2 such that the yoke b of the funnel 2 has a substantially rectangular vertical cross section.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

As apparent from the above description, the frame according to the present invention, which is applied to a cathode ray tube, includes a side wall having an optimal height and a bottom wall having an optimal width to increase the intrinsic frequency of the frame, and thus, to prevent occurrence of a howling phenomenon caused by resonance.

In accordance with the present invention, it is also possible to prevent occurrence of an electron beam shielding phenomenon and a halation phenomenon by appropriately modify the structures of the side and bottom walls of the frame designed to prevent occurrence of a howling phenomenon.

What is claimed is:

1. A cathode ray tube comprising a panel, a funnel coupled to a rear end of the panel, a shadow mask formed with a plurality of slots to perform a color selecting function for electron beams, and a frame adapted to support the shadow mask, wherein:
the frame comprises a side wall, to which the shadow mask is welded, and a bottom wall extending from the side wall in a state of being bent inwardly of the frame; and
the side wall of the frame has a height defined in a cross section of the frame taken along a longer axis (x) of the frame to satisfy the following condition, and the bottom wall of the frame has a width defined in the cross section of the frame taken along the longer axis (x) of the frame to satisfy the following condition:
1.29≦FW_{—}x/FH_{—}x≦1.90
where, “FW_x” represents the height of the side wall in the cross section of the frame taken along the longer axis (x) of the frame, and “FH_x” represents the width of the bottom wall in the cross section of the frame taken along the longer axis (x) of the frame.

2. The cathode ray tube according to claim 1, wherein the side wall of the frame has a height defined in a cross section of the frame taken along a shorter axis (y) of the frame to satisfy the following condition, and the bottom wall of the frame has a width defined in the cross section of the frame taken along the shorter axis (y) of the frame to satisfy the following condition:
0.70≦FW_{—}y/FH_{—}y≦1.10
where, “FW_y” represents the height of the side wall in the cross section of the frame taken along the shorter axis (y) of the frame, and “FH_y” represents the width of the bottom wall in the cross section of the frame taken along the shorter axis (y) of the frame.

3. The cathode ray tube according to claim 1, wherein the side wall of the frame has a height defined in a cross section of the frame taken along a diagonal axis (d) of the frame to satisfy the following condition, and the bottom wall of the frame has a width defined in the cross section of the frame taken along the diagonal axis (d) of the frame to satisfy the following condition:
1.49≦FW_{—}d/FH_{—}d≦1.91
where, “FW_d” represents the height of the side wall in the cross section of the frame taken along the diagonal axis (d) of the frame, and “FH_d” represents the width of the bottom wall in the cross section of the frame taken along the diagonal axis (d) of the frame.

4. The cathode ray tube according to claim 1, wherein the values “FH_x” and “FW_x” of the cathode ray tube satisfy the following conditions, respectively:
42 mm≦FH_x≦54 mm, and
63 mm≦FW_x≦93 mm.

5. The cathode ray tube according to claim 1, wherein the cathode ray tube satisfies the following condition:
1.80≦Dx/L≦2.52
where, “L” represents a distance from a deflection center of the cathode ray tube to an edge of a skirt of the panel in a direction parallel to a central axis (z) of the panel, and “Dx” represents a distance from the central axis (z) of the panel to an edge of the bottom wall of the frame in a direction parallel to the longer axis (x).

6. The cathode ray tube according to claim 1, wherein the cathode ray tube satisfies the following condition:
0.80≦θx/βx≦0.90
where, “θx” represents a deflection angle, at which an electron beam strikes a reflecting surface of a reflecting tip of the frame extending along the longer axis (x), and “βx” represents an angle formed between a line extending perpendicularly to the longer-axis reflecting surface of the reflecting tip and a central axis (z) of the panel.

7. The cathode ray tube according to claim 1, wherein the cathode ray tube has a size ranging from 28 inches to 32 inches.

8. The cathode ray tube according to claim 1, wherein the cathode ray tube satisfies the following condition:
tan⁻¹(W/H)≧1.05
where, “H” represents a distance from a deflection center of the cathode ray tube to a center of an outer surface of the panel, and “W” represents a distance from the outer surface center of the panel to an edge of an effective screen of the panel in a diagonal direction of the panel.

9. The cathode ray tube according to claim 1, wherein the funnel comprises a yoke having a substantially rectangular vertical cross-sectional shape.

10. A cathode ray tube comprising a panel, a funnel coupled to a rear end of the panel, a shadow mask formed with a plurality of slots to perform a color selecting function for electron beams, and a frame adapted to support the shadow mask, wherein:
the frame comprises a side wall, to which the shadow mask is welded, and a bottom wall extending from the side wall in a state of being bent inwardly of the frame; and
the side wall of the frame has a height defined in a cross section of the frame taken along a short axis (y) of the frame to satisfy the following condition, and the bottom wall of the frame has a width defined in the cross section of the frame taken along the shorter axis (y) of the frame to satisfy the following condition:
0.70≦FW_{—}y/FH_{—}y≦1.10
where, “FW_y” represents the height of the side wall in the cross section of the frame taken along the shorter axis (y) of the frame, and “FH_y” represents the width of the bottom wall in the cross section of the frame taken along the shorter axis (y) of the frame.

11. The cathode ray tube according to claim 10, wherein the side wall of the frame has a height defined in a cross section of the frame taken along a diagonal axis (d) of the frame to satisfy the following condition, and the bottom wall of the frame has a width defined in the cross section of the frame taken along the diagonal axis (d) of the frame to satisfy the following condition:
1.49≦FW_{—}d/FH_{—}d≦1.91
where, “FW_d” represents the height of the side wall in the cross section of the frame taken along the diagonal axis (d) of the frame, and “FH_d” represents the width of the bottom wall in the cross section of the frame taken along the diagonal axis (d) of the frame.

12. The cathode ray tube according to claim 10, wherein the values “FH_y” and “FW_y” of the cathode ray tube satisfy the following conditions, respectively:
53 mm≦FH_y≦67 mm, and
42 mm≦FW_y≦66 mm.

13. The cathode ray tube according to claim 10, wherein the cathode ray tube satisfies the following condition:
0.90≦Dy/L≦1.41
where, “L” represents a distance from a deflection center of the cathode ray tube to an edge of a skirt of the panel in a direction parallel to a central axis (z) of the panel, and “Dy” represents a distance from the central axis (z) of the panel to an edge of the bottom wall of the frame in a direction parallel to the shorter axis (y).

14. The cathode ray tube according to claim 10, wherein the cathode ray tube satisfies the following condition:
0.65≦θy/βy≦0.85
where, “θy” represents a deflection angle, at which an electron beam strikes a reflecting surface of a reflecting tip of the frame extending along the shorter axis (y), and “βy” represents an angle formed between a line extending perpendicularly to the shorter-axis reflecting surface of the reflecting tip and a central axis (z) of the panel.

15. The cathode ray tube according to claim 10, wherein the cathode ray tube has a size ranging from 28 inches to 32 inches.

16. The cathode ray tube according to claim 10, wherein the cathode ray tube satisfies the following condition:
tan⁻¹(W/H)≧1.05
where, “H” represents a distance from a deflection center of the cathode ray tube to a center of an outer surface of the panel, and “W” represents a distance from the outer surface center of the panel to an edge of an effective screen of the panel in a diagonal direction of the panel.

17. The cathode ray tube according to claim 10, wherein the funnel comprises a yoke having a substantially rectangular vertical cross-sectional shape.

18. A cathode ray tube comprising a panel, a funnel coupled to a rear end of the panel, a shadow mask formed with a plurality of slots to perform a color selecting function for electron beams, and a frame adapted to support the shadow mask, wherein:
the frame comprises a side wall, to which the shadow mask is welded, and a bottom wall extending from the side wall in a state of being bent inwardly of the frame; and
the side wall of the frame has a height defined in a cross section of the frame taken along a diagonal axis (d) of the frame to satisfy the following condition, and the bottom wall of the frame has a width defined in the cross section of the frame taken along the diagonal axis (d) of the frame to satisfy the following condition:
1.49≦FW_{—}d/FH_{—}d≦1.91
where, “FW_d” represents the height of the side wall in the cross section of the frame taken along the diagonal axis (d) of the frame, and “FH_d” represents the width of the bottom wall in the cross section of the frame taken along the diagonal axis (d) of the frame.

19. The cathode ray tube according to claim 18, wherein:
the side wall of the frame has a height defined in a cross section of the frame taken along a longer axis (x) of the frame to satisfy the following condition, and the bottom wall of the frame has a width defined in the cross section of the frame taken along the longer axis (x) of the frame to satisfy the following condition:
1.29≦FW_{—}x/FH_{—}x≦1.90
where, “FW_x” represents the height of the side wall in the cross section of the frame taken along the longer axis (x) of the frame, and “FH_x” represents the width of the bottom wall in the cross section of the frame taken along the longer axis (x) of the frame; and
the side wall of the frame has a height defined in a cross section of the frame taken along a shorter axis (y) of the frame to satisfy the following condition, and the bottom wall of the frame has a width defined in the cross section of the frame taken along the shorter axis (y) of the frame to satisfy the following condition:
0.70≦FW_{—}y/FH_{—}y≦1.10
where, “FW_y” represents the height of the side wall in the cross section of the frame taken along the shorter axis (y) of the frame, and “FH_y” represents the width of the bottom wall in the cross section of the frame taken along the shorter axis (y) of the frame.

20. The cathode ray tube according to claim 18, wherein the values “FH_d” and “FW_d” of the cathode ray tube satisfy the following conditions, respectively:
38 mm≦FH_d≦48 mm, and
64 mm≦FW_d≦82 mm.

21. The cathode ray tube according to claim 18, wherein the cathode ray tube satisfies the following condition:
1.99≦Dd/L≦3.04
where, “L” represents a distance from a deflection center of the cathode ray tube to an edge of a skirt of the panel in a direction parallel to a central axis (z) of the panel, and “Dd” represents a distance from the central axis (z) of the panel to an edge of the bottom wall of the frame in a direction parallel to the diagonal axis (d).

22. The cathode ray tube according to claim 18, wherein the cathode ray tube satisfies the following condition:
0.80≦θd/βd≦0.95
where, “θd” represents a deflection angle, at which an electron beam strikes a reflecting surface of a reflecting tip of the frame extending along the diagonal axis (d), and “βd” represents an angle formed between a line extending perpendicularly to the diagonal-axis reflecting surface of the reflecting tip and a central axis (z) of the panel.

23. The cathode ray tube according to claim 18, wherein the cathode ray tube has a size ranging from 28 inches to 32 inches.

24. The cathode ray tube according to claim 18, wherein the cathode ray tube satisfies the following condition:
tan⁻¹(W/H)≧1.05
where, “H” represents a distance from a deflection center of the cathode ray tube to a center of an outer surface of the panel, and “W” represents a distance from the outer surface center of the panel to an edge of an effective screen of the panel in a diagonal direction of the panel.

25. The cathode ray tube according to claim 18, wherein the funnel comprises a yoke having a substantially rectangular vertical cross-sectional shape.
